(19) United States
(12) Patent Application Publication
(10) Pub. No.: US 2013/0101059 A1
(43) Pub. Date: Apr. 25, 2013

(54) Pre-modulation physical layer steganography

(71) Applicants: Ira S. Moskowitz, Washington, DC (US); Pedro N. Safier, Alexandria, VA (US); Paul Cotae, Potomac, MD (US)

(72) Inventors: Ira S. Moskowitz, Washington, DC (US); Pedro N. Safier, Alexandria, VA (US); Paul Cotae, Potomac, MD (US)

(21) Appl. No.: 13/573,671

(22) Filed: Oct. 3, 2012

Related U.S. Application Data
(60) Provisional application No. 61/542,361, filed on Oct. 3, 2011.

(51) Int. Cl. H04L 27/00

(52) U.S. Cl. CPC H04L 27/00
USPC 375/259

(57) ABSTRACT

A method for physical layer steganography communications is provided by combining an encoded cover data stream with a hidden data stream to create stego data stream. The cover and hidden data streams can be combined by determining an insertion rate, and determining, for each bit of the hidden data stream, whether to change an associated bit in the cover data stream. The bit of the cover data stream is changed to match the hidden data stream when the two bits are different. Otherwise, the cover data stream bit stays the same. The stego data stream can then be modulated and transmitted to a receiver. At the receiver, the stego data stream can be split to extract the hidden data stream, and the cover data stream can be decoded.

### CROSS-REFERENCE TO RELATED APPLICATIONS

This application claims priority to provisional patent application entitled, “Pre-Modulation Physical Layer Steganography,” filed on Oct. 3, 2011, and assigned U.S. Application No. 61/542,361; the entire contents of which are hereby incorporated by reference.

### FIELD OF THE INVENTION

The invention relates generally to physical-layer steganography. More particularly, the invention relates to a method of hiding a digital data stream within another digital data stream at the physical-layer level before the modulation stage.

### BACKGROUND

In communications, often users want to guarantee that the message content they are relaying is available only to an intended recipient. One way to do this is through encryption. However, sometimes users prefer to hide the very fact that the communication is taking place, and to achieve this it is necessary to use steganography. Steganography is the concept of hiding information by embedding messages within other, seemingly harmless messages. For example, a digital data stream can be hidden within a multimedia file, such as a voice, text, or image file. Alternatively, another purpose can be to add a watermark to the original message to authenticate its contents or claim ownership.

More recently, other steganography approaches are being considered, such as hiding data in network protocols and at the physical-layer level. Existing physical-layer steganography methods typically embed the hidden data stream after the modulation stage. However, these methods have some disadvantages. For example, the hidden signal must be much weaker than the cover signal to avoid detection. Therefore, the hidden message must be sent with a low signal-to-noise ratio. In addition, the post-modulation methods create a change in the noise distribution; therefore, making detection possible through statistical analysis.

Accordingly, there remains a need in the art for a method of hiding a digital data stream within another digital data stream at the physical-layer level before the modulation stage.

### SUMMARY OF THE INVENTION

According to one aspect of the invention, a method for physical layer steganography communications is provided by combining an encoded cover data stream with a hidden data stream to create a stego (steganographic) data stream. The cover and hidden data streams can be combined by specifying an insertion rate, and determining, for each bit of the hidden data stream, whether to change an associated bit in the cover data stream. The bit of the cover data stream is changed to match the hidden data stream when the two bits are different. Otherwise, the cover data stream bit stays the same. The stego data stream can then be modulated and transmitted to a receiver. At the receiver, the stego data stream can be split to extract the hidden data stream, and the cover data stream can be decoded, and the errors introduced by the hidden data and the noisy channel corrected.

According to another aspect of the invention, a system for physical layer steganography communications is provided that includes a stego encoder that is configured to combine a cover data stream with a hidden data stream to create a stego data stream. A modulator can then be configured to modulate the stego data stream, and a receiver can be configured to receive the modulated stego data stream via a communications channel. Finally a stego decoder can be configured to split the stego data stream to decode the hidden data stream at the receiver.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a flow chart illustrating a prior art process for hiding a digital data stream within another digital data stream at the physical-layer level after the modulation stage.

FIG. 2 is a block diagram illustrating an exemplary system for hiding a digital data stream within another digital data stream at the physical-layer level before the modulation stage in accordance with an exemplary embodiment of the invention.

FIG. 3 is a chart representing an example of an execution of the insertion process in accordance with an exemplary embodiment of the invention.

FIG. 4 is a chart representing an example of an execution of the decoding process of the stego output data stream in accordance with an exemplary embodiment of the invention.

### DETAILED DESCRIPTION OF EXEMPLARY EMBODIMENTS

Referring now to the drawings, in which like numerals represent like elements, aspects of the exemplary embodiments will be described in connection with the drawing set.

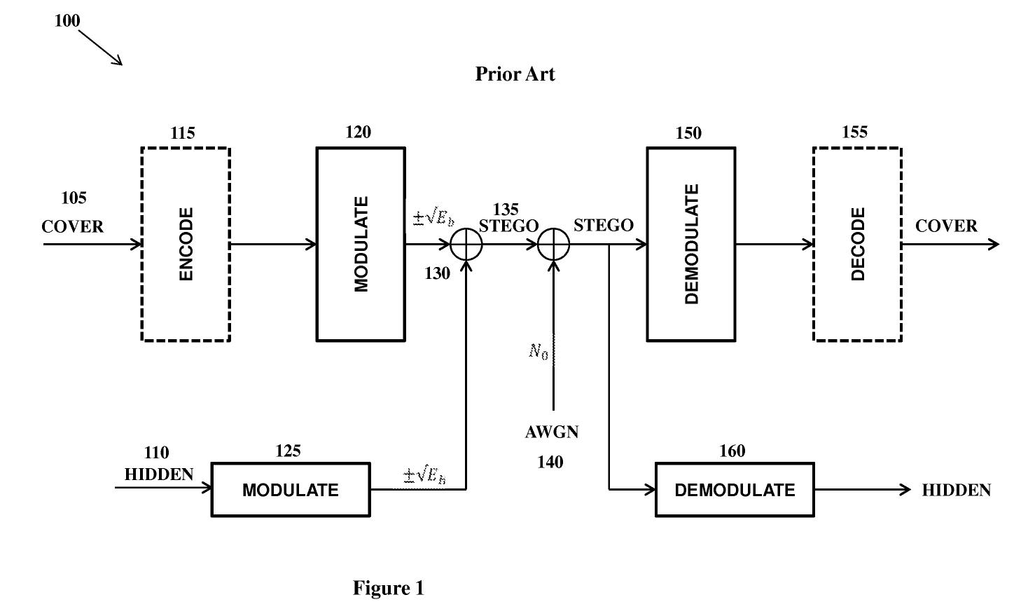

FIG. 1 is a flow chart 100 illustrating a prior art process for hiding a digital data stream within another digital data stream at the physical-layer level after the modulation stage. In this prior art example, a simple model single input single output (SISO) communication channel subject only to additive white Gaussian noise (AWGN) is presented. In the flow chart 100, a cover data stream 105 is utilized to hide the hidden data stream 110. In this method, the cover data stream 105 is encoded 115 and modulated 120 separate from the hidden data stream 110, which is also modulated 125. After the modulation stages 120 and 125, the hidden data stream 110 is joined at 130 to the cover data stream 105, which creates the steganographic, or “stego,” data stream 135.

As noted, the communication channel through which the stego data stream 135 passes between the sender and recipient is subject only to AWGN 145. After passing to the recipient through the communication channel, the stego data stream 135 is split back into the cover data stream 105 and hidden data stream 110. The cover data stream 105 is demodulated 150 and decoded 155, and the hidden data stream 110 is demodulated 160.

In evaluating and determining whether the prior art flow chart 100 presents an acceptable steganography method, the hidden data stream 110 is treated as additive noise. Additionally, a bit error rate (BER), which is dependent upon the signal to noise ratio (SNR), is adopted as an evaluation metric. Therefore, to determine whether the prior art method is effective, the question is whether the noise introduced by the embedding of the hidden data stream 110 is compatible, for a given SNR, with the BER expected from the AWGN inherent to the cover data stream 105. Essentially, under what circumstances would an eavesdropper attribute any corruption of cover message to natural noise? If an eavesdropper did assume any corruption was just natural noise, then the steganography would be considered strong (i.e., successful).

Therefore, in the prior art method system in the flow chart 100, to avoid detection, the power level of the hidden data stream 110 has to be defined, and it has to be much lower than the power level of the cover data stream 105. Otherwise, if noise levels exceeded that defined level, suspicion could be created about the message. Furthermore, the addition of the hidden data stream 110 after the modulation stage 125 can change the statistical distribution of the noise measured at the output of the cover data stream 105. Therefore, an analysis of that cover data stream 105 at the output could create suspicion. Both of these issues, if not precisely accounted for in the prior art flow chart 100, make the system susceptible to detection by an eavesdropper.

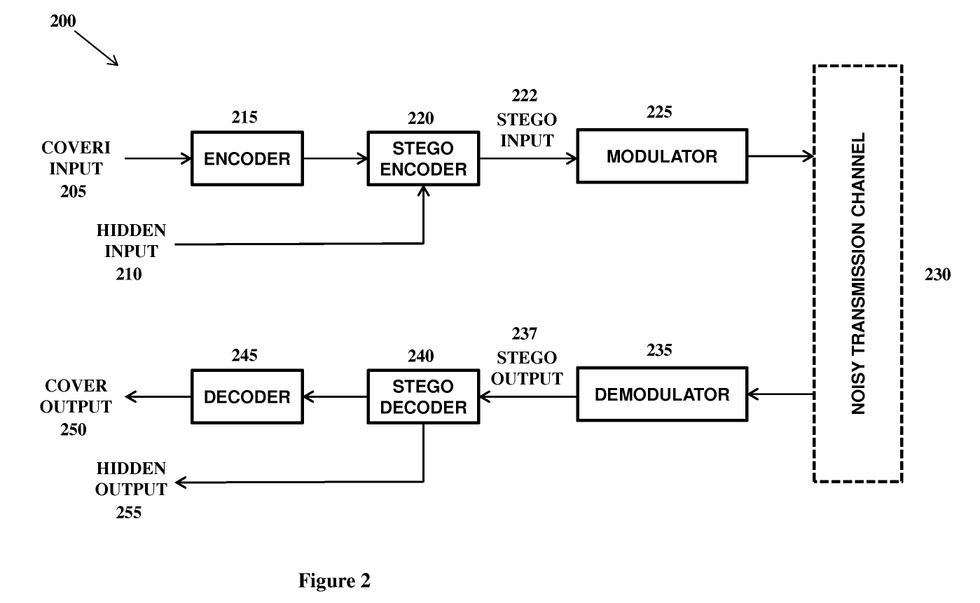

FIG. 2 is a block diagram 200 illustrating an exemplary system for hiding a digital data stream within another digital data stream at the physical-layer level before the modulation stage in accordance with an exemplary embodiment of the invention. Accordingly, FIG. 2 can overcome the issues of the prior art system of FIG. 1 because, in short, the hidden data stream 210, or hidden input, can be added to the cover data stream 205, or cover input, before the modulation stage 225. Therefore, the hidden and cover messages can have the same power level, while the statistical distribution of the communication channel's noise is not affected.

More specifically, in accordance with an exemplary embodiment of the invention, the block diagram 200 of FIG. 2 discloses a communication link, that can send data through a memory-less noisy transmission channel 230, which can be any channel subject to additive white Gaussian Noise, through which equally-probable symbols can be sent using, for example, binary phase-shift keying (BPSK) modulation. One of ordinary skill in the art will understand that this modulation scheme is the simplest, but at the same time it is very robust against channel noise. The robustness can increase the challenge of steganographically hiding a message within the noise. One of ordinary skill in the art will understand that different encodings with increasing error-correction capabilities can be utilized. Therefore, it is critical that the channel be noisy, as the hidden data is hidden as noise, and that the communication link use an error-correction encoding scheme. The stronger the channel noise, the more data that can be hidden. Similarly, the stronger the error correction capabilities of the encoding method, the larger the hidden data payload. Finally, one of ordinary skill in the art will understand that different encodings can be utilized.

In the block diagram 200, a cover input data stream 205 can be utilized to hide a hidden data stream 210. The cover input data stream 205 can be any message in digital form after a quantization stage, such as a cover message. The hidden input data stream 210 can be any message in digital form after a quantization and encoding stage, such as a hidden message. In an alternative embodiment, the hidden input data stream 210 can be a digital watermark to authenticate the cover message, or to claim ownership of the cover data. More specifically, a fragile digital watermark can be sent where the strength of the authenticity is dependent on the stealthiness of the method.

In this system, the cover input data stream 205 is encoded with an encoder 215, which can be a standard digital encoder, and then combined with the hidden input data stream 210 by a stego encoder 220 to create a stego input data stream 222, which includes the combined cover and hidden messages in a data stream.

In an exemplary embodiment of the invention, a method for combining the hidden input data stream 210 with the cover input data stream 205 to create the stego input data stream 222 with a stego encoder 220 is described herein. M_{c} and Mₕ can be defined to be the lengths (in bits) of the cover input data stream 205, or cover message, and the hidden input data stream 210, or hidden message, respectively. The hidden message can be inserted at a fixed rate, “insertion rate,” of one bit inserted every Rₛ bits of the cover message where

$${R}_{s} = \frac{{M}_{c}}{{M}_{h}} >> 1.$$

For example, if the cover input data stream 205 was 16 bits long, and the hidden input data stream 210 was 4 bits long, then the insertion rate would be 4. That is, one bit of the hidden input data stream 210 could be inserted at every 4 bits of the cover input data stream 205, or more specifically, at the 4^{th}, 8^{th}, 12^{th} and 16^{th} bits. One of ordinary skill in the art will understand that the insertion rate must be an integer number, though other equations for calculating the insertion rate could be utilized.

After specifying the insertion rate and the length of the hidden message the process of inserting the hidden input message bits 210 into the cover message input bit stream 205 can be performed. Initially, the sender and receiver have to agree on the value of the insertion rate and the length of the hidden message. In general, though discussed in more detail below, whenever a hidden bit is inserted at the calculated insertion rate, a cover bit can be flipped, e.g., changed from 1 to 0 or from 0 to 1, if it differs from the hidden bit that is being inserted. In contrast, if the cover bit and the hidden bit are the same, then nothing can be done and the cover bit can stay the same. This process can be repeated until all of the hidden bits have been inserted. Because the cover message has on average the same number of zeros and one, on the average only half of the hidden bits will modify the respective cover bits.

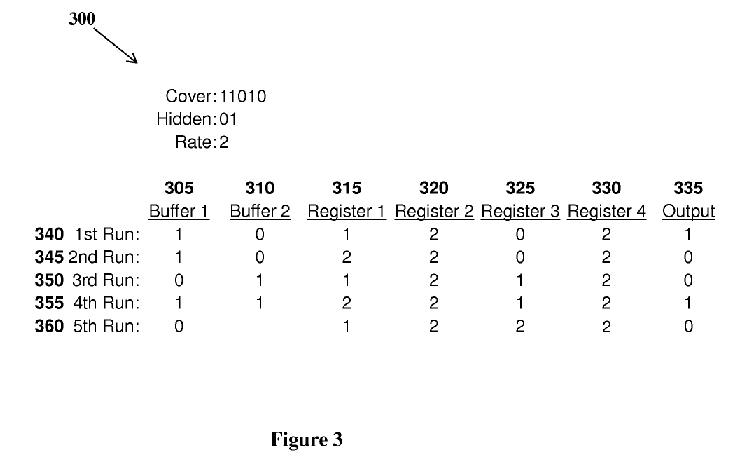

FIG. 3 is a chart 300 representing an example of an execution of the insertion process in accordance with an exemplary embodiment of the invention. The stego encoder 220 can consist of two input bit streams, one output bit stream, two bit buffers, and four registers. One buffer, buffer 1 305, can be used to store one bit of the cover message, and another buffer, buffer 2 310 can be used to store a bit from the hidden message. One register, register 1 315, can be used to store the number of bits processed from the cover message, and a second register, register 2 320, can be used to store the numerical value of the desired insertion rate of the hidden message. Register 3 325 can be used to keep a running count of the number of hidden bits inserted, and register 4 330 can be used to store the length of the hidden message. Finally, units to compare the values in the buffers, registers, and to increment the value of the registers can also be utilized, as well as standard units to push bits in and out of the buffers. One of ordinary skill in the art will understand that the components discussed are all standard digital electronic components.

In an exemplary embodiment of the invention, if the value of register 3 325 is less than the value in register 4 330, then next determine if the value of register 1 315 is less than the value of register 2 320. If the value of register 1 315 is less than the value of register 2 320, then the bit in buffer 1 305 can be put in the output 335 and the next cover bit can pushed into buffer 1 305, and the value of register 1 315 can be incremented by one. Otherwise, if the value of register 1 315 is not less than the value of register 2 320, the output 335 can be the bit value of buffer 2 310; the next bit from the cover message can pushed into buffer 1 305; the next bit from the hidden message can be pushed into buffer 2 310; the value of register 1 315 can be reset to one; and the value of register 3 325 can be incremented by one. The process continues until all the bits from the hidden message are processed, which is noted if the value of register 3 325 is not less than the value in register 4 330. Therefore, if the value in register 3 325 is not less than the value stored in register 4 330, only bits from the cover stream, if any are left, can be put in the output 335.

By way of example, in association with FIG. 3, a cover message of 11010 will be used with a hidden message of 01. Therefore, the insertion rate is 2 because 4 bit cover divided by 2-bit hidden equals 2.

Upon initialization of the process, the first bit from the cover message, 1, and the first bit from the hidden message, 0, can be stored in the respective buffers, buffer 1 305 and buffer 2 310. This is represented in the “First run” row 340 in FIG. 3. The value of register 1 315 is initialized to one, representing that the 1^{st} bit of the cover message is being processed. Furthermore, register 2 320 is initialized to the insertion rate of 2, register 3 325 is initialized to zero, and register 4 330 is set to the length of the hidden message, two.

Therefore, in accordance with the example in FIG. 3, for the 1^{st} run 340, the value in register 3 325 is 0, which is less than the value of register 4 330, which is 2. Therefore, the next step is to compare the value of register 1 315 with register 2 320. The value of register 1 315 is 1, which is less than the value of register 2 320, which is 2. Therefore, the bit in buffer 1 305, which is 1, is put in the output 335 and the next cover bit, which is 1, is pushed into buffer 1 305. Finally, value of register 1 315 is incremented by one to the value of 2.

During the 2^{nd} run 345, the value in register 3 325 is 0, which is less than the value of register 4 330, which is 2. Therefore, the next step is to compare the value of register 1 315 with register 2 320. The value of register 1 315 is 2, which is not less than the value of register 2 320, which is also 2. Therefore, the output 335 for the 2^{nd} run 345 is the bit value of buffer 2 310, which is 0. The next bit from the cover message, which is 0, is pushed into buffer 1 305. The value of register 3 325 is incremented by one to 1. Furthermore, since the new value stored in register 3 325, which is 1, is less than the value stored in register 4 330, which is 2, then the next bit from the hidden message, which is 1, is pushed into buffer 2 310. Finally, the value of register 1 315 is reset to one.

During the 3^{rd} run 350, the value in register 3 325 is 1, which is less than the value of register 4 330, which is 2. Therefore, the next step is to compare the value of register 1 315 with register 2 320. The value of register 1 315 is 1, which is less than the value of register 2 320, which is 2. Therefore, the bit in buffer 1 305, which is 0, is put in the output 335 and the next cover bit, which is 1, is pushed into buffer 1 305. Finally, value of register 1 315 is incremented by one to the value of 2.

During the 4^{th} run 355, the value in register 3 325 is 1, which is less than the value of register 4 330, which is 2. Therefore, the next step is to compare the value of register 1 315 with register 2 320. The value of register 1 315 is 2, which is not less than the value of register 2 320, which is 2. Therefore, the output 335 for the 4^{th} run 355 is the bit value of buffer 2 310, which is 1. The next bit from the cover message, which is 0, is pushed into buffer 1 305. The value of register 3 325 is incremented by one to 2. Therefore, since the new value stored in register 3 325, which is 2, is not larger than the value stored in register 4 330, which is also 2, this signals that all hidden bits have been processed. Therefore, no more bits are pushed into buffer 2 310. Finally, the value of register 1 315 is reset to one.

Finally, during the 5^{th} run 360, the value in register 3 325 is 2, which is not less than the value of register 4 330, which is 2. Therefore, all of the hidden bits have been processed, and only cover bits, if any left are passed to the output 335. In this example, the bit in buffer 1 305, which is a 0, is passed to the output 335. Therefore, the full output 335 provides the stego data stream 222, which is 10010.

The stego data stream 222, or stego input data stream, can then be modulated with a modulator 225 if the modulator 225 is part of the communication link. One of ordinary skill in the art will understand that the modulator 225 can be a standard modulator for telecommunications. The modulated stego data stream 222 can then be transmitted to a receiver through a through a communication channel 230. The communication channel 230 can be a noisy transmission channel, which is a transmission medium subject to additive white Gaussian Noise.

One of ordinary skill in the art will understand that certain communication links do not require modulation. For example, the link between the input to a computer and the output to a hard drive does not require modulation. Such links resort only to encoding and the transmission channel is the electronic components required to write onto the hard drive, a channel that is subject to AWGN.

After passing to the recipient, or receiver, through the noisy communication channel 230, the stego input data stream 222 can be demodulated with a demodulator 235. One of ordinary skill in the art will understand that the demodulator 235 can be a standard modulator for telecommunications. The digital output of the demodulator 235 can be the stego output data stream 237. Next, the stego output data stream 237 can be split to decode the hidden output data stream 255 and cover output data stream 250 from the stego output data stream 237 with a stego decoder 240. The hidden output data stream 255 is the recovered hidden message in digital form.

In accordance with an exemplary embodiment of the invention, the entire stego output data stream 237 can be decoded bit by bit according to the insertion rate, i.e., all the bits are output as cover bits, and every Rₛ bit, a copy of the input bit is made and decoded as part of the hidden message as long as the number of bits thus processed does not exceed the specified length of the hidden message. More specifically, every bit of the stego data stream is output as a cover bit, and each bit associated with the hidden data stream, as determined by the decoding process, is output as a hidden bit. After processing through all the bits of the stego output data stream 237, the recipient is then left with the cover output data stream 250, which after decoding with a decoder 245 is the recovered cover message in digital form, and the hidden output data stream 255, which is the recovered hidden message in digital form. One of ordinary skill in the art will understand that the recipient is aware of the insertion rate and the length of the hidden message utilized to originally create the stego input data stream 222 on the sender side.

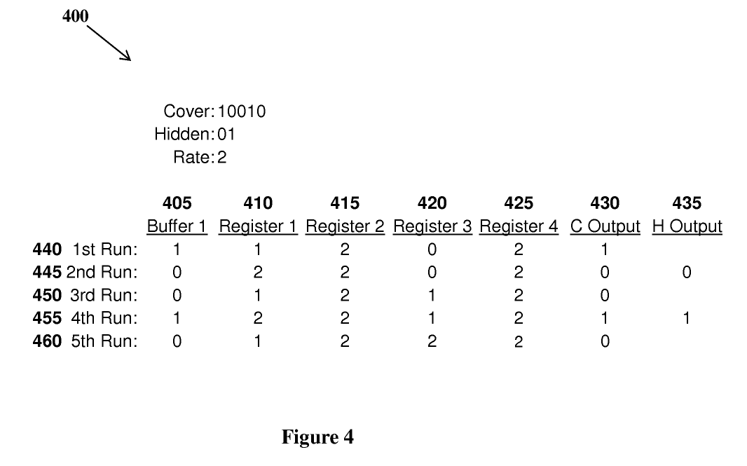

FIG. 4 is a chart 400 representing an example of an execution of the decoding process of the stego output data stream in accordance with an exemplary embodiment of the invention. More specifically, the stego decoder 240 can include one input bit stream and two output bit streams for the recovered cover and hidden messages, respectively. Additionally, the stego decoder 240 can include four registers. For example, register 1 410 can be used to store the number of input bits processed. Register 2 415 can be used to store the numerical value of the desired insertion rate of the hidden message. Register 3 420 can be used to keep a running count of the number of hidden bits decoded. Finally, Register 4 425 can be used to store the length of the hidden message. Additionally, the stego decoder 240 can include a unit to compare the numerical values in registers 1 410 and 2 415, and registers 3 420 and 4 425. Finally, the stego decoder 240 can include a bit buffer 405, which can be used to store one bit of the stego output data stream 237.

In an exemplary embodiment of the invention, if the value of register 3 420 is less than the value in register 4 425, then next determine if the value of register 1 410 is less than the value of register 2 415. If the value of register 1 410 is less than the value of register 2 415, then the bit in buffer 405 can be put in the cover stream output 430. Then, the next bit of the stego output data stream can pushed into buffer 405, and the value of register 1 410 can be incremented by one. Otherwise, if the value of register 1 410 is not less than the value of register 2 415, the cover stream output 430 and the hidden stream output 435 can both be the bit value of the buffer 405. The next bit from the stego output data stream can pushed into the buffer 405; the value of register 1 410 can be reset to one; and the value of register 3 420 can be incremented by one. The process continues until all the bits from the hidden message are decoded and output to the hidden stream output 435. In that instance, the value of register 3 420 is not less than the value in register 4 425. Therefore, after this happens, no more input bits are added to hidden stream output 435 and all the remaining input bits can be put in the cover stream output 430.

By way of example, in association with FIG. 4, a stego output data stream of 10010 will be used with a hidden message of 01. Therefore, the insertion rate is 2 because 4 bit cover divided by 2-bit hidden equals 2.

Upon initialization, the first bit from the stego output data stream 237, which is 1 in the example associated with FIG. 3, can be stored in the buffer 405. Register 1 410 can be initialized to one, and register 2 415 can be initialized to the insertion rate of the hidden message, which is 2. Register 3 420 can be initialized to zero, and the length of the hidden message, which is 2, can be stored in register 4 425.

Therefore, in accordance with the example in FIG. 4, for the 1^{st} run 440, the value in register 3 420 is 0, which is less than the value of register 4 425, which is 2. Therefore, the next step is to compare the value of register 1 410 with register 2 415. The value of register 1 410 is 1, which is less than the value of register 2 415, which is 2. Therefore, the bit in buffer 405, which is 1, is put in the cover stream output 430 and the next stego output bit, which is 0, is pushed into buffer 405. Finally, value of register 1 410 is incremented by one to the value of 2.

During the 2^{nd} run 445, the value in register 3 420 is 0, which is less than the value of register 4 425, which is 2. Therefore, the next step is to compare the value of register 1 410 with register 2 415. The value of register 1 410 is 2, which is not less than the value of register 2 415, which is also 2. Therefore, the cover stream output 430 and the hidden stream output 435 are both the bit value of the buffer 405, which is 0. The next bit from the stego output, which is 0, is pushed into buffer 405. The value of register 3 420 is incremented by one to 1. Finally, the value of register 1 410 is reset to one.

During the 3^{rd} run 450, the value in register 3 420 is 1, which is less than the value of register 4 425, which is 2. Therefore, the next step is to compare the value of register 1 410 with register 2 415. The value of register 1 410 is 1, which is less than the value of register 2 415, which is 2. Therefore, the bit in buffer 405, which is 0, is put in the cover stream output 430 and the next stego output bit, which is 1, is pushed into buffer 405. Finally, value of register 1 410 is incremented by one to the value of 2.

During the 4^{th} run 355, the value in register 3 420 is 1, which is less than the value of register 4 425, which is 2. Therefore, the next step is to compare the value of register 1 410 with register 2 415. The value of register 1 410 is 2, which is not less than the value of register 2 415, which is also 2. Therefore, the cover stream output 430 and the hidden stream output 435 are both the bit value of the buffer 405, which is 1. The next bit from the stego output, which is 0, is pushed into buffer 405. The value of register 3 420 is incremented by one to 2. Finally, the value of register 1 410 is reset to one.

Finally, during the 5^{th} run 460, the value in register 3 420 is 2, which is not less than the value of register 4 330, which is 2. Therefore, all of the hidden message bits have been decoded, as the hidden stream output 435 reflects a hidden message of 01, as expected. The final step is to push the remaining bit in the buffer 405, which is 0, to the cover stream output 430. As noted, after the stego decoder 240 processing, the hidden output data stream 255, which is the recovered hidden message in digital form, is available. Separately, the cover output data stream 250 can be decoded with a standard digital decoder 245. The result of this output is the cover output data stream 250 or the recovered cover message in digital form.

The exemplary embodiment of the invention presented in the block diagram 200 of FIG. 2 overcomes at least three limitations of the prior art block diagram 100 of FIG. 1. Specifically, the embodiment exploits the error-correcting capabilities of the encoding for the original input data stream 205, to hide the hidden stream as noise. That is, even though the cover input data stream 205 has bits that are altered by adding the hidden input data stream 210, the error-correcting encoding that occurs on the receiver side resolves those discrepancies and the cover input data stream 205 appears as it did originally as long as the resulting bit error rate (BER) is within one or two standard deviations of the average BER expected. Essentially, the hidden input data stream 210 is disguised as noise that can be subsequently corrected.

Secondly, the signal strength of the hidden input data stream 210 and the original cover input data stream 205 are the same making the reception and recovery of the hidden input data stream 210 easier than in previous physical-layer steganography methods.

Finally, the original cover input data stream 205 statistics are not changed, which makes it harder for an eavesdropper to detect.

It should be understood that the foregoing relates only to illustrative embodiments of the present invention, and that numerous changes may be made therein without departing from the scope and spirit of the invention as defined by the following claims.

1. A method for physical layer steganography communications, comprising the steps of:
combining a cover data stream with a hidden data stream to create a stego data stream with a stego encoder;
modulating the stego data stream with a modulator and transmitting to a receiver via a communications channel; and
splitting the stego data stream with a stego decoder to decode the hidden data stream at the receiver.

2. The method of claim 1, wherein the hidden data stream comprises a hidden message.

3. The method of claim 1, wherein the hidden data stream comprises a digital watermark to authenticate the cover data stream.

4. The method of claim 1, wherein the cover data stream is encoded.

5. The method of claim 1, wherein the step of combining the cover data stream with the hidden data stream to create a stego data stream comprises the steps of:
specifying an insertion rate and a length of the hidden data stream; and
determining, for each bit of the hidden data stream, whether to change a corresponding bit in the cover data stream.

6. The method of claim 5, wherein the step of determining, for each bit of the hidden data stream, whether to change a corresponding bit in the cover data stream comprises the steps of:
comparing the bit of the hidden data stream to the corresponding bit of the cover data stream based on the insertion rate; and
changing the associated bit of the cover data stream to match the hidden data stream if the comparing steps shows that the bits are different.

7. The method of claim 1, wherein the step of splitting the stego data stream to decode the hidden data stream at the receiver comprises the step of the decoding the entire stego output data stream bit by bit according to the insertion rate, wherein every bit of the stego data stream is output as a cover bit, and each bit associated with the hidden data stream is output as a hidden bit.

8. The method of claim 1, further comprising the step of decoding the stego data stream to produce the cover data stream by removing errors introduced by the hidden data stream.

9. A system for physical layer steganography communications, comprising:
a stego encoder configured to combine a cover data stream with a hidden data stream to create a stego data stream;
a modulator configured to modulate the stego data stream;
a receiver configured to receive the modulated stego data stream via a communications channel; and
a stego decoder configured to split the stego data stream to decode the hidden data stream at the receiver.

10. The system of claim 9 further comprising an encoder to encode the cover data stream.

11. The method of claim 9, wherein the hidden data stream comprises a hidden message.

12. The method of claim 9, wherein the hidden data stream comprises a digital watermark to authenticate the cover data stream.
